(19) United States
(12) Patent Application Publication
(10) Pub. No.: US 2013/0262967 A1
(43) Pub. Date: Oct. 3, 2013

(54) INTERACTIVE ELECTRONIC MESSAGE APPLICATION

(71) Applicant: AMERICAN GREETINGS CORPORATION, Cleveland, OH (US)

(72) Inventors: Jo Ann Dreher, Wooster, OH (US); Carol Miller, Twinsburg, OH (US); David Mayer, Bay Village, OH (US); Jorge E. Barrionuevo, Madrid (ES); Carolina Alvares de Azevedo Gomes, Minas Gerais (BR)

(73) Assignee: AMERICAN GREETINGS CORPORATION, Cleveland, OH (US)

(21) Appl. No.: 13/834,977

(22) Filed: Mar. 15, 2013

Related U.S. Application Data
(60) Provisional application No. 61/619,808, filed on Apr. 3, 2012.

(51) Int. Cl. G06F 17/24

(52) U.S. Cl. CPC G06F 17/24
USPC 715/202

(57) ABSTRACT

An interactive electronic greeting card and message application comprising a digital character, wherein the digital character responds to a user's input by providing an audio or visual response. The user's input and the digital character's audio or visual response are recorded for subsequent storage or distribution. The user input may be in the form of a voice command or a movement or a sound. The audio or visual response may be in the form of a sound, or a pre-recorded answer, or a changed graphical representation of the digital character. The interactive electronic greeting card application may be hosted on a portable computing device.

### RELATED APPLICATIONS

This application claims the benefit of and priority to U.S. Provisional Application No. 61/619,808, entitled “INTERACTIVE MEDIA APPLICATION WITH AUDIO VISUAL RECORDING CAPABILITIES,” which was filed on Apr. 3, 2012. The entire disclosure of this application (U.S. Provisional Application No. 61/619,808) is incorporated herein by reference.

### FIELD

The present invention relates to an interactive electronic message application, and, more particularly, to an interactive electronic message or greeting card application that provides for creating, displaying, editing, distributing and viewing of digital content with voice and video recordings and other audio-visual features.

### BACKGROUND

Greeting cards and other electronic messages have been ubiquitous tools of personal expression in modern times. Lately, electronic greeting cards and messages have taken an ever increasing role in sending and receiving communications between individuals and more simply recording messages or other information. Electronic greeting cards have been largely focused on providing a customizable user experience by providing users the ability to modify text and photos.

In parallel, with the expanding availability of inexpensive storage media and computing, large amounts of audio and video data is being created and distributed over the Internet. Especially, portable computing devices such as smartphones and tablet computers have been increasingly used to create and distribute digital content.

### BRIEF SUMMARY

The general inventive concepts contemplate systems, methods, and apparatuses for creating, displaying, editing, distributing and viewing of high-resolution interactive electronic greeting cards and messages for present day and future portable computing devices and their technologies. By way of example, to illustrate various aspects of the general inventive concepts, several exemplary embodiments of systems methods and/or apparatuses are disclosed herein.

Systems, methods, and apparatuses, according to one exemplary embodiment, contemplate an interactive application, which allows the users to fully customize and personalize the content of an interactive electronic greeting card and/or message.

Systems, methods, and apparatuses, according to one exemplary embodiment, contemplate an interactive electronic greeting card application or electronic message application, which allows the users to embed audio and visual data along with an interactive electronic greeting or message.

Systems, methods, and apparatuses, according to one exemplary embodiment, contemplate an interactive application comprising a digital character, wherein the digital character responds to a user's input by providing an audio and/or visual response. The user's input and the digital character's audio visual response are recorded for subsequent storage or distribution. The user input may be in the form of a voice command or a movement or a sound. The audio visual response may be in the form of a sound, or a pre-recorded answer, a changed graphical representation of the digital character or a combination of any of these items. The interactive application may be hosted on a portable computing device or any other computing device. The portable computing device (or other computing device), the interactive electronic message application, and the user are in communication with a server via one or more communications systems, such as the Internet.

Additional features and advantages will be set forth in part in the description that follows, and in part will be obvious from the description, or may be learned by practice of the embodiments disclosed herein. The objects and advantages of the embodiments disclosed herein will be realized and attained by means of the elements and combinations particularly pointed out in the appended claims. It is to be understood that both the foregoing brief summary and the following detailed description are exemplary and explanatory only and are not restrictive of the embodiments disclosed herein or as claimed.

### BRIEF DESCRIPTION OF THE DRAWINGS

The accompanying drawings, which are incorporated in and constitute a part of this specification, illustrate some exemplary embodiments disclosed herein, and together with the description, serve to explain principles of the exemplary embodiments disclosed herein.

FIG. 1 is a flow chart depicting a high level flow of the inventive system.

FIG. 2 is a high level overview of the interactions between the hardware, the software, and the users in the inventive system.

FIG. 3 is an exemplary screenshot of a home screen of a portable computing device.

FIG. 4 is an exemplary screenshot of a welcome screen of the interactive electronic greeting card application.

FIG. 5 is an exemplary screenshot of an entry screen of the interactive electronic greeting card application.

FIG. 6 is an exemplary screenshot of a welcome message by a digital character of the interactive electronic greeting card application.

FIG. 7 is an exemplary screenshot of a ready state of a digital character of the interactive electronic greeting card application.

FIG. 8 is an exemplary screenshot of a digital character providing an audiovisual response.

FIG. 9 is an exemplary screenshot of a digital character snoring/sleeping in response to a user's silence or no-movement.

FIG. 10 is an exemplary screenshot of a ready state of a digital character of the interactive electronic greeting card application, along with a record feature of the application being shown activated.

FIG. 11 is an exemplary screenshot of various storage and distribution options available in the interactive electronic greeting card application.

FIG. 12 is an exemplary screenshot of a digital character in playback mode.

FIG. 13 is an exemplary screenshot of a user's sharing experience of the interactive electronic greeting card application with Facebook® friends.

FIG. 14 is an exemplary screenshot of a user's sharing experience of the interactive electronic greeting card application on their own Facebook® page.

FIG. 15 is an exemplary screenshot of a user's sharing experience of the interactive electronic greeting card application via email.

FIG. 16 is an exemplary screenshot of a user saving a recorded interaction for later use.

FIG. 17 is an exemplary screenshot of a user choosing to enter a digital character carousel.

FIG. 18 is an exemplary screenshot of a digital character carousel.

FIG. 19 is an exemplary screenshot of a user selecting a digital character to download and install from a digital character carousel.

FIG. 20 is an exemplary screenshot of a digital character after download.

FIGS. 21-22 are exemplary screenshots of digital characters available to a user.

FIG. 23 is an exemplary screenshot of an information page.

FIG. 24 is an exemplary screenshot of a greeting card information page.

FIG. 25 is an exemplary screenshot of a store locator homepage

FIG. 26 is an exemplary screenshot of listing of stores after a store locator search.

FIG. 27 is an exemplary screenshot of a search result listed on a map.

FIG. 28 is an exemplary screenshot of driving directions from a zip code or address to a selected store.

FIG. 29 is an exemplary screenshot of a settings page.

### DETAILED DESCRIPTION

The exemplary embodiments disclosed herein will now be described by reference to some more detailed embodiments, with occasional reference to the accompanying drawings. These exemplary embodiments may, however, be embodied in different forms and should not be construed as limited to the embodiments set forth herein. Rather, these exemplary embodiments are provided so that this disclosure will be thorough and complete, and will fully convey the scope of the embodiments to those skilled in the art. The description of the exemplary embodiments below do not limit the terms used in the claims in any way. The teens of the claims have all of their full, ordinary meaning.

Unless otherwise defined, all technical and scientific terms used herein have the same meaning as commonly understood by one of ordinary skill in the art to which these embodiments belong. The terminology used in the description herein is for describing exemplary embodiments only and is not intended to be limiting of the embodiments. As used in the specification, the singular forms “a,” “an,” and “the” are intended to include the plural fauns as well, unless the context clearly indicates otherwise. All publications, patent applications, patents, and other references mentioned herein are incorporated by reference in their entirety.

The following are definitions of exemplary terms used throughout the disclosure. Both singular and plural forms of all terms fall within each meaning:

“Computer” or “processing unit” as used herein includes, but is not limited to, any programmed or programmable electronic device, microprocessor, or logic circuit that can store, retrieve, and process data.

“Portable computing devices” include, but are not limited to, computing devices which combine the powers of a conventional computer in portable environments. Exemplary portable computing devices include portable computers, tablet computers, internet tablets, Personal Digital Assistants (PDAs), ultra mobile PCs (UMPCs), carputers (typically installed in automobiles), wearable computers, and smartphones. The term “portable computing device” can be used synonymously with the terms “computer” or “processing unit.”

A “web browser” as used herein, includes, but is not limited to, software for retrieving and presenting information resources on the World Wide Web. An information resource may be a web page, an image, a video, a sound, or any other type of electronic content.

“Software” or “computer program” or “application software” as used herein includes, but is not limited to, one or more computer or machine readable and/or executable instructions that cause a computer, a portable computing device, microprocessor, logic circuit, or other electronic device to perform functions, actions, and/or behave in a desired manner. The instructions may be embodied in various forms such as routines, algorithms, modules or programs, including separate applications or code from dynamically linked libraries. Software may also be implemented in various forms such as a stand-alone program, an app, a function call, a servlet, an applet, instructions stored in a memory or any other computer readable medium, part of an operating system or other type of executable instructions. It will be appreciated by one of ordinary skill in the art that the form of software is dependent on, for example, requirements of a desired application, the environment it runs on, and/or the desires of a designer/programmer or the like.

“Mobile application” or “mobile app” or “software application” or “application” or “app” as used herein, includes, but is not limited to, applications that run on smart phones, tablet computers, and other mobile or portable computing devices. The terms “mobile application” or “mobile app” or “software application” or “application” or “app” can be used synonymously with “software” or “computer program” or “application software.” Mobile applications allow users to connect to services which are traditionally available on the desktop or notebook platforms. Typically, these services access the internet or intranet or cellular or wireless fidelity (Wi-Fi) networks, to access, retrieve, transmit and share data.

A “network” as used herein, includes, but is not limited to, a collection of hardware components and computers or machines interconnected by communication channels that allow sharing of resources and information, including without limitation, the worldwide web or internet.

A “server” as used herein, includes, but is not limited to, a computer or a machine or a device on a network that manages network resources. The general term “server” may include specific types of servers, such as a File Server (a computer and storage device dedicated to storing files), Print Server (a computer that manages one or more printers), a Network Server (a computer that manages network traffic), and a Database Server (a computer system that processes database queries). Although servers are frequently dedicated to performing only server tasks, certain multiprocessing operating systems allow a server to manage other non-server related resources.

A “web server” as used herein, includes, but is not limited to, a server which serves content to a web browser by loading a file from a disk and serving it across a network to a user's web browser, typically using a hyper text transfer protocol (HTTP).

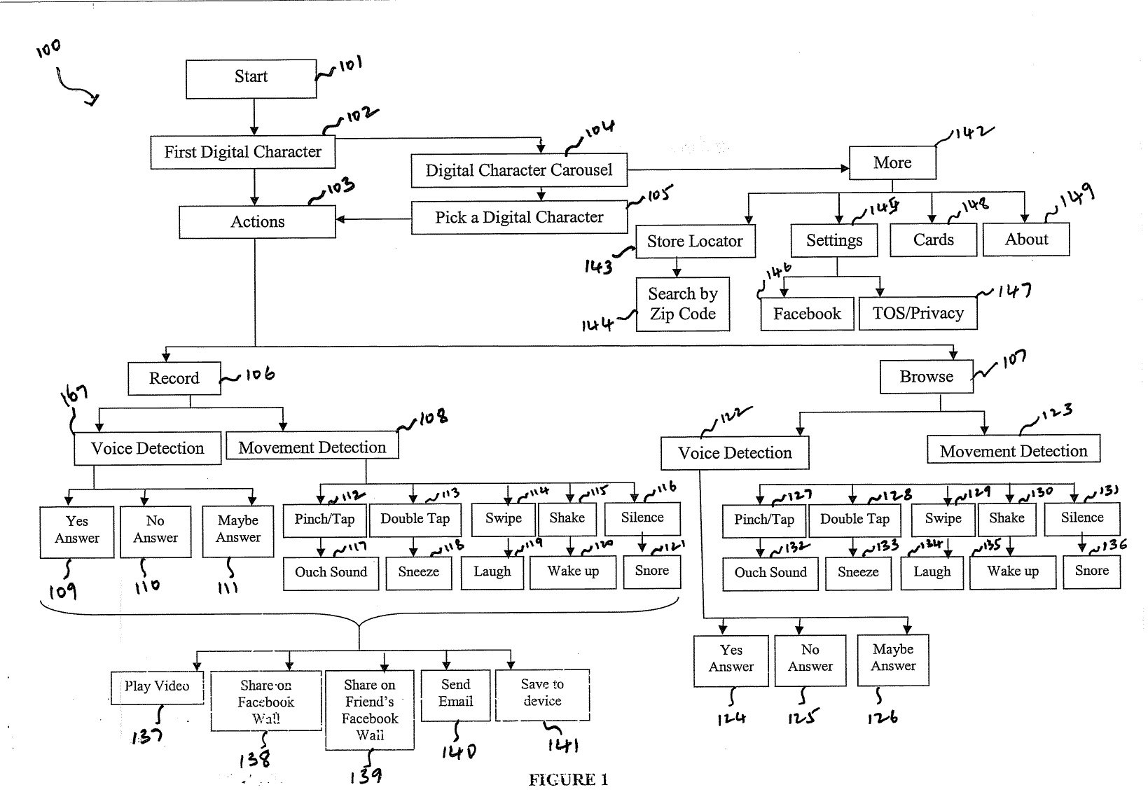

Reference will now be made to the drawings. FIG. 1 is a flow chart of system 100 of the present invention. The system flow begins at step 101. The system flow in this FIG. 1 is the flow of the software of this exemplary embodiment. At 102, an interactive electronic greeting card or message user (“user”) is presented a first digital character. At this step, the user may either perform certain actions on the first digital character (step 103) or choose to enter a mustache carousel (step 104) to pick and download one ore more additional digital characters (step 105).

If the user elects proceed to step 104 and select and download one or more new digital characters at step 105, the user will then be re-directed to the action step at 103 after the selection and downloading of the new digital character(s). Essentially, the user interacts with one digital character at a time.

When the user arrives at step 103, the user has the ability to perform two actions on the selected digital character: (1) record (step 106); and (2) browse (step 107). Regardless of the choice between steps 106 and 107, the user is presented with the same set of interactive choices as a follow-up. For example, steps 167 and 108 correspond to steps 122 and 123 respectively. Similarly, steps 109-111 correspond to steps 124-126, steps 112-116 correspond to steps 127-131, and steps 117-121 correspond to steps 132-136, respectively.

However, at step 106, if the user chooses to record their interactions with the digital character as opposed to simply browsing their interactions (as in step 107), the user is presented with additional steps 137-141 which will be described in further detail below. For the sake of brevity, only one set of user interactive choices outlined in steps 167 and 108-121 will be described in further detail. It will be understood that steps 122-136 correspond with steps 167 and 108-121 in both features and functionality, except that steps 167 and 108-121 are performed in conjunction with a user's recording of the interactive electronic greeting card screens while steps 122-136 are performed in conjunction with the user simply browsing the interactive electronic greeting card screens.

As the user first interacts with a digital character, the digital character is in a “ready” state. The user chooses to record the interactive session with the interactive electronic greeting card application at step 106. The user then initiates interaction with the digital character by either voice or movement. The digital character detects the user's voice at step 167 and the user's movement at step 108. If the user interacts with the digital character by speaking in an audible proximity of the portable computing device hosting the interactive electronic message application, the digital character responds by either providing an affirmative answer (step 109), a negative answer (step 110), or a “maybe” answer (step 111). All these answers are pre-recorded and are hosted as part of the interactive electronic message application on the portable computing device. The user may interact with the interactive electronic greeting card/message application by speaking or making any sound. In a preferred embodiment, the user interacts with the interactive electronic message application by speaking “questions” or “inquiries” or “statements” or “sounds” to which the interactive electronic greeting card application would respond with its “answers” or “sounds.” The answers are intended to set one or more moods within the interactive message card application, including, but not limited to, humor.

The user may also interact with the interactive electronic message by making a movement on the portable computing device and/or the interactive electronic greeting card application. With the interactive electronic message application open, the user may pinch or tap the screen of the portable computing device (at step 112), resulting in the digital character making an “ouch” sound (step 117). With the interactive electronic message application open, the user may double tap the screen of the portable computing device (at step 113), resulting the digital character making an “sneezing” sound (step 118). With the interactive electronic message application open, the user may swipe the screen of the portable computing device (at step 114), resulting the digital character making a “laughing” sound (step 119). With the interactive electronic message application open, the user may shake the portable computing device (at step 115), resulting the digital character “waking up” making an appropriate “awake” sound (step 120). With the interactive electronic message application open, the user may allow for no interaction with the portable computing device or the interactive electronic message application (at step 116), resulting in the digital character making a “snoring” sound (step 121).

Any voice and or movement by the user is detected as explained above, and the subsequent interactions with the user are recorded by the interactive electronic message application. The user then has a choice of additional steps in steps 137-141. The user is either able to play the video previously recorded (at step 137), share the recorded video on Facebook® (at step 138), share the recorded video on a friend's Facebook® profile (at step 139), send the recorded video via email (at step 140), or save the recorded video to the memory of the portable computing device (at step 141).

The user is also able to access an additional menu of options at step 142. Accordingly, the user may choose to locate stores by selecting the store locator option at step 143. Using this option the user is able to search, either by address or zip code or both, for stores which may be carrying a paper card version of the interactive electronic greeting cards/messages used in this application (step 144). The users may also generally search for stores which may carry any paper greeting cards or other products (step 144). The users may also choose the “Cards” option at step 148 to obtain additional information about the interactive electronic greeting card/message application or any other paper or electronic greeting cards. The user may select the About option at step 149 to get additional information regarding the interactive electronic greeting card/message application and/or the promoters of the interactive electronic message application. The user may also select the Settings option at step 1445 to either review the terms of service, privacy and other legal documents (at step 147), or to turn on/off their Facebook® login.

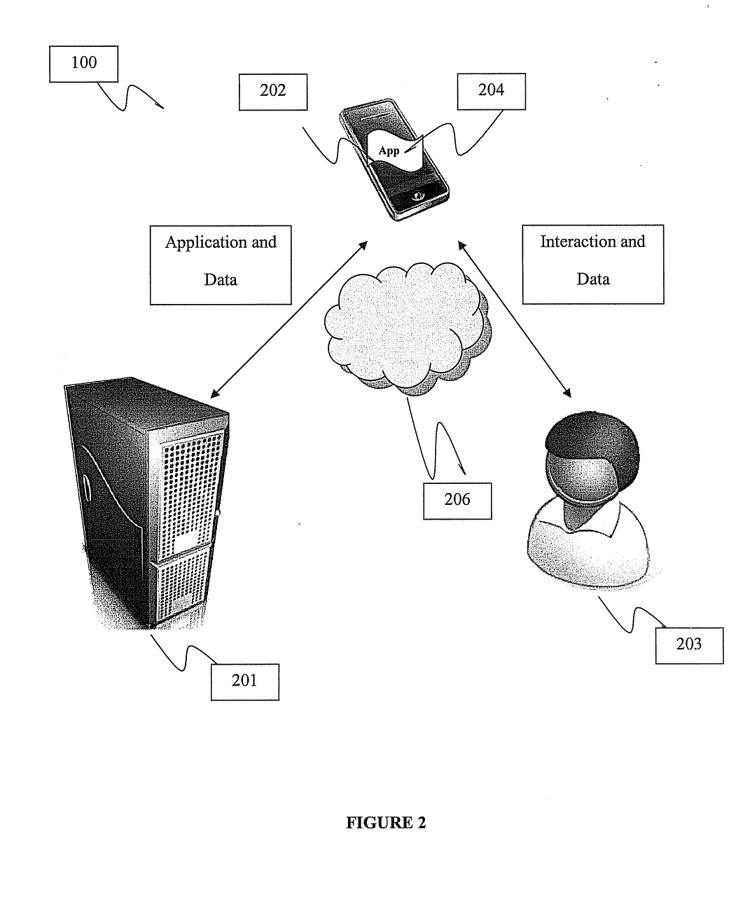

Referring now to FIG. 2, a high-level representation of the system 100, and in particular, the user's operation with reference to the interactive electronic greeting card/message application is shown. One or more users 203 interact with a portable computing device 202, which hosts the interactive electronic message application 204. The interactive electronic message application 204 is downloaded from a server 201 on to the portable computing device 202. The interactive electronic message application 204 is initially downloaded with all the functional features and one or more digital characters (not shown). Every time the user 203 accesses the interactive electronic greeting card/message application 204 after initial download, the user 203 is then able to download additional digital characters from the server 201.

While the server 201 is shown here as a single server for simplicity's sake, the server 201 may represent an application server, a database server, a web server, or any combination of servers or configuration of servers necessary for the present invention. The server 201 may include one computer system or a plurality of computer systems. The portable computing device 202 may have a memory device to store and retrieve data, and it is in communication with the server 201 via one or more communications systems, such as the Internet 206. Similarly, one or more users 203 is in communication with portable computing device 202 via one or more communications systems, such as the Internet 206.

In one embodiment, the type of “communication” referenced above in relation to system 100 may be a “Circuit communication” type. Circuit communication as used herein is used to indicate a communicative relationship between devices. Direct electrical, optical, and electromagnetic connections and indirect electrical, optical, and electromagnetic connections are examples of circuit communication. Two devices are in circuit communication if a signal from one is received by the other, regardless of whether the signal is modified by some other device. For example, two devices separated by one or more of the following—satellites, routers, gateways, transformers, optoisolators, digital or analog buffers, analog integrators, other electronic circuitry, fiber optic transceivers, etc.—are in circuit communication if a signal from one reaches the other, even though the signal is modified by the intermediate device(s). As a final example, two devices not directly connected to each other (e.g. keyboard and memory), but both capable of interfacing with a third device, (e.g., a CPU), are in circuit communication.

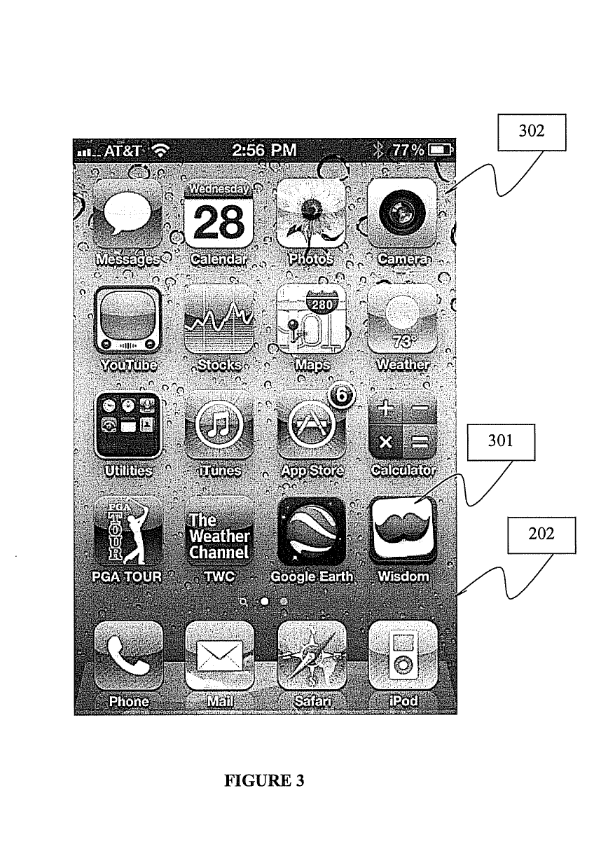

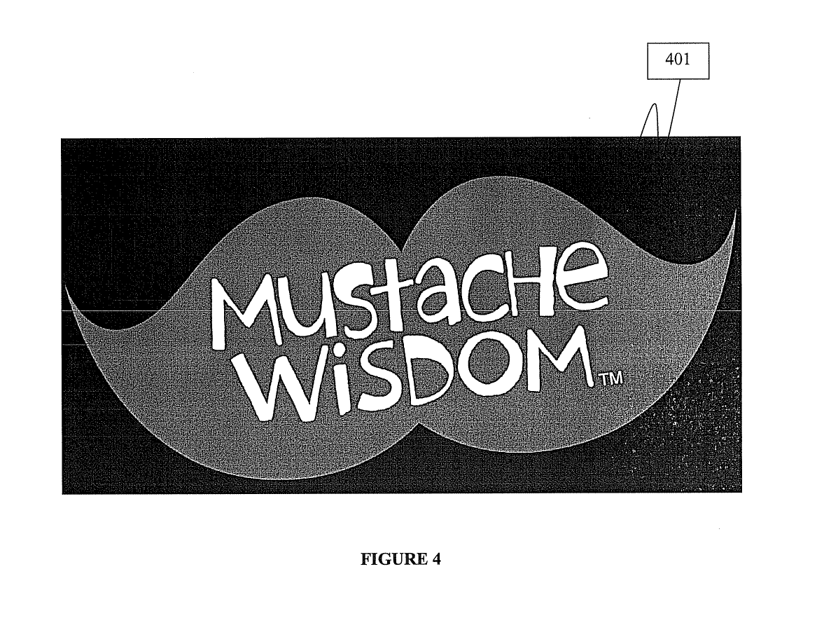

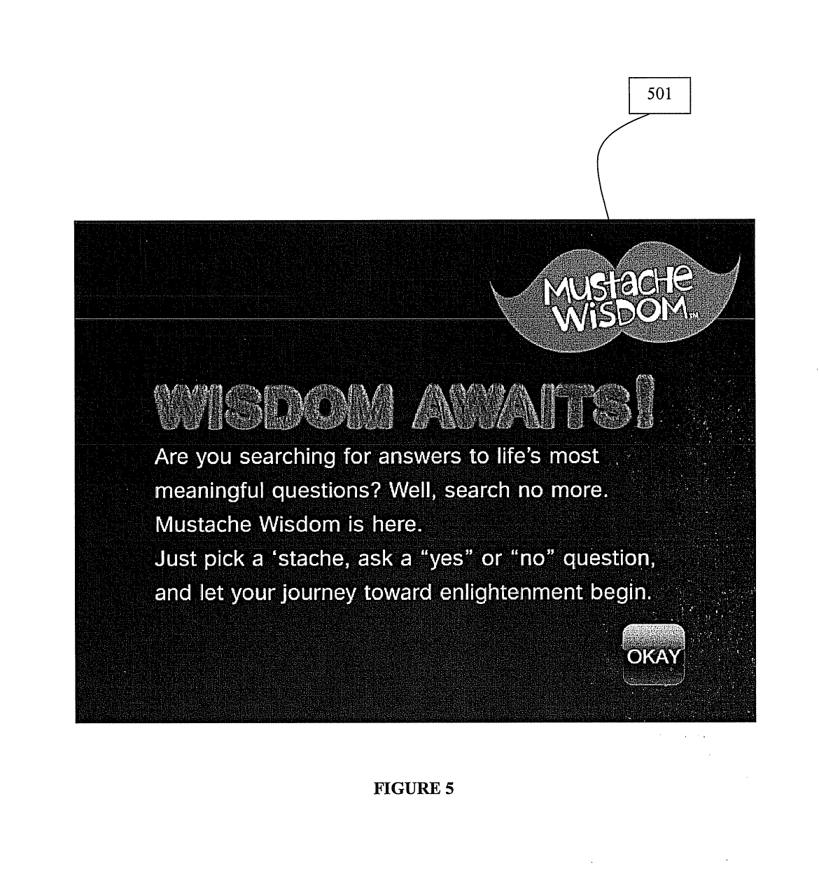

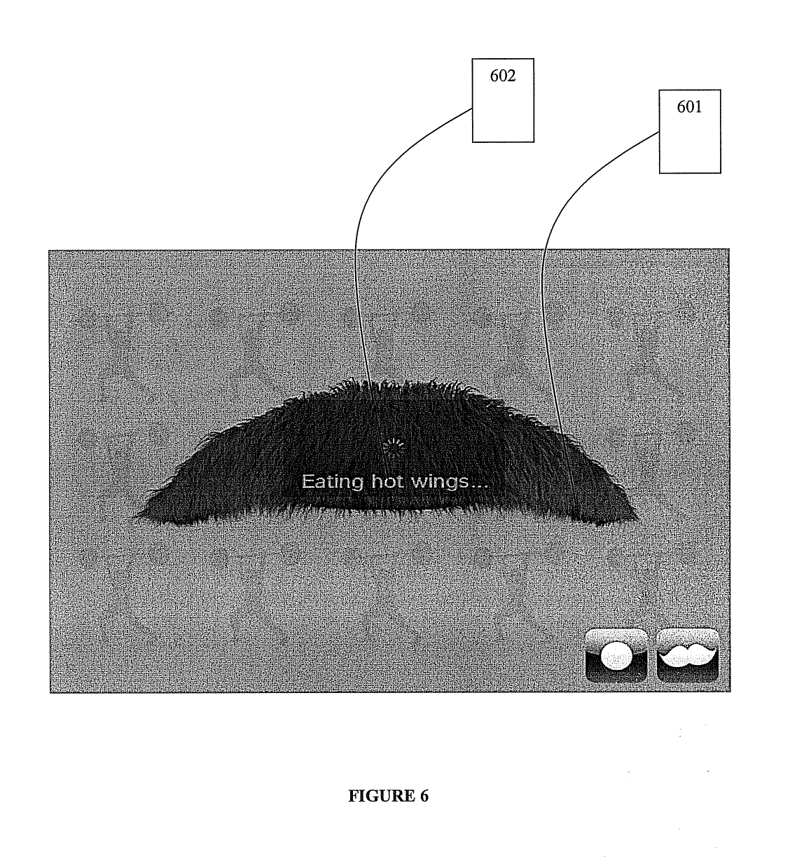

In one exemplary embodiment, as illustrated in FIG. 3, the user 203 may initiate the interactive electronic greeting card/message application 204 (“app”) by tapping on the application icon 301 on the screen 302 of a portable computing device 202. The user 203 is then directed to a welcome screen 401, as illustrated in FIG. 4. Thereafter, the user 203 may interact with the app 204 by selecting to “enter” the app 204, as shown in screen 501 of FIG. 5. While the user 203 selects the “OK” link in screen 501, the user 203 is not limited to such a link, and may select any other area designed to allow entry into the app 204. In another embodiment, the user 203 may skip the steps outlined in FIGS. 4 and 5 and proceed directly from the icon 301 to the app 204 as described in FIG. 6 below.

Once the user 203 enters the app 204, the user 203 is greeted by a digital character. In the preferred embodiment, the digital character is a digital mustache 601, as shown in FIG. 6. In one embodiment, each digital mustache 601 is represented by its own unique greeting style. For example, with reference to FIG. 6, user 203 is greeted by a digital mustache 601 styled “Manly Stache,” which welcomes the user 203 by the greeting style “Eating hot wings . . . ” 602. One of ordinary skill in the art would appreciate that the digital mustache may be of any shape, size, visual, auditory or functional character, and, is not restricted to the embodiment shown in FIG. 6. Further, one of ordinary skill in the art would appreciate that the language used within the app 204, and by the digital mustache 601, is not limited to English, as the app 204 and the digital mustache 601 may utilize any language capable of being rendered within a mobile application or digital communication via software.

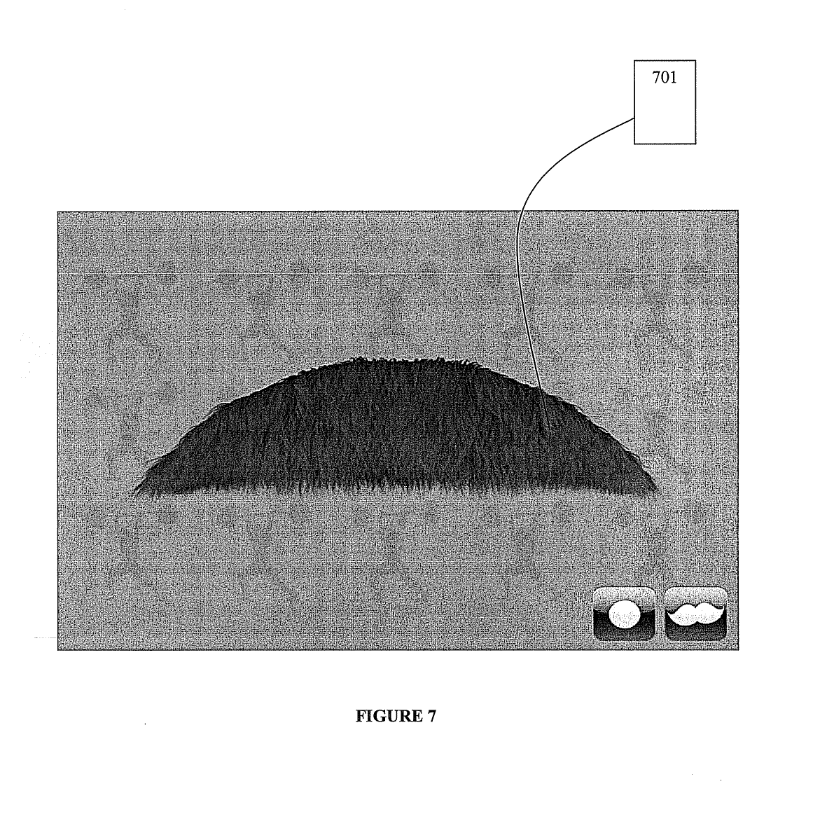

After the initial greeting, the digital mustache 601 goes into a “ready” state as shown by the screen 701 in FIG. 7. The duration of the ready state may be defined within the software of the app 204. The user 203 may then interact with the digital mustache 601 by initiating either a voice or a movement activity. With reference to a voice interaction, user 203 may interact with the digital mustache by simply speaking or by making a sound within an audible proximity of the portable computing device 202 hosting the app 204. In terms of the movement interaction, the user 203 may pinch/tap, double tap, swipe, shake the app 204 using the screen 302 and/or the portable computing device 202 (or choose to stay silent). The digital mustache 601 detects either the user's voice or sound or the user's movement and responds by either providing an affirmative, negative, or maybe answer (for voice or sound interaction), or making one of many sounds (for movement interaction). The sounds include, but not limited to, “ouch,” “sneeze,” “laugh,” “waking up,” and “snore.”

In a preferred embodiment, the user 203 interacts with the app 204 by speaking “questions” or “sounds” or “inquiries” to the digital mustache 601, to which the digital mustache 601 would respond with its “answers” or “sounds.” The answers are intended to set one or more moods within the app 204, including, but not limited to, humor. All the answers are pre-recorded within the app 204 and are hosted as part of the app 204 on the portable computing device 202. For example, in one embodiment, the digital mustache 601 is pre-built with fifty (50) pre-recorded answers. One of ordinary skill in the art will appreciate that any number of pre-recorded answers can be built into each digital mustache 601, and the pre-recorded answers may be added or deleted to the digital mustache 601 at any time. The answers may be accessed and rendered either in a random fashion, or via an algorithmic approach within the software of the app 204. The algorithmic approach may be fashioned to recognize the pitch, tone, speed or other variables of the user's voice and render an appropriate pre-recorded response. For example, if the input is a deep toned, man's voice, the response may be tailored to target the preferences of a man for the mood targeted, for example humor or joy or happiness. The same tailoring of the response can be done if the voice detected or input is a high-pitched and/or man's voice.

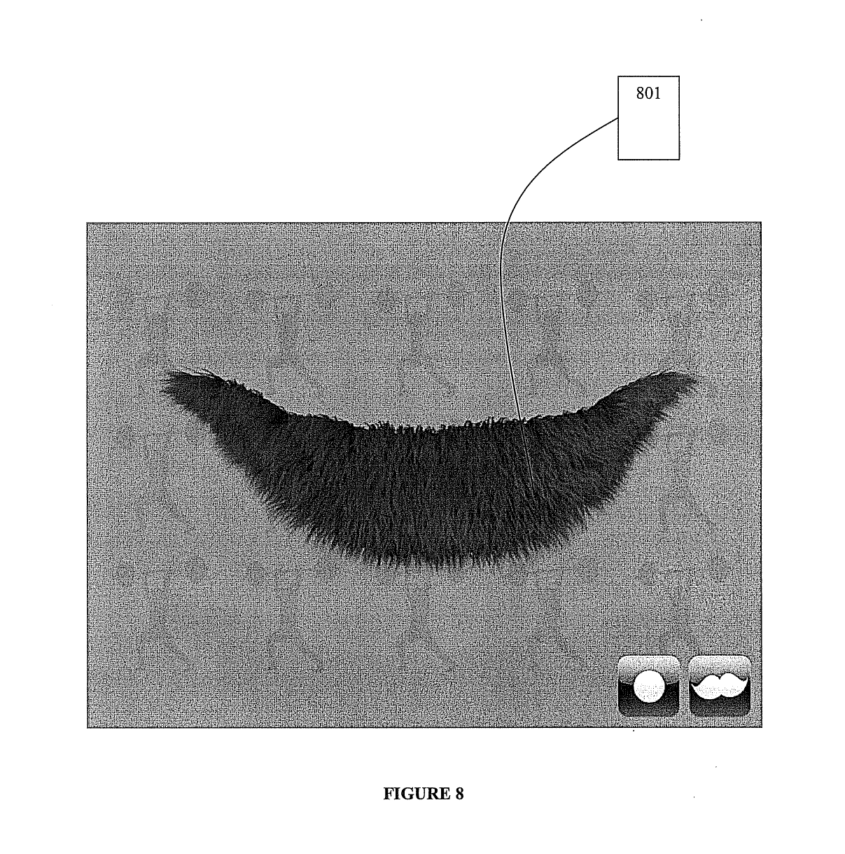

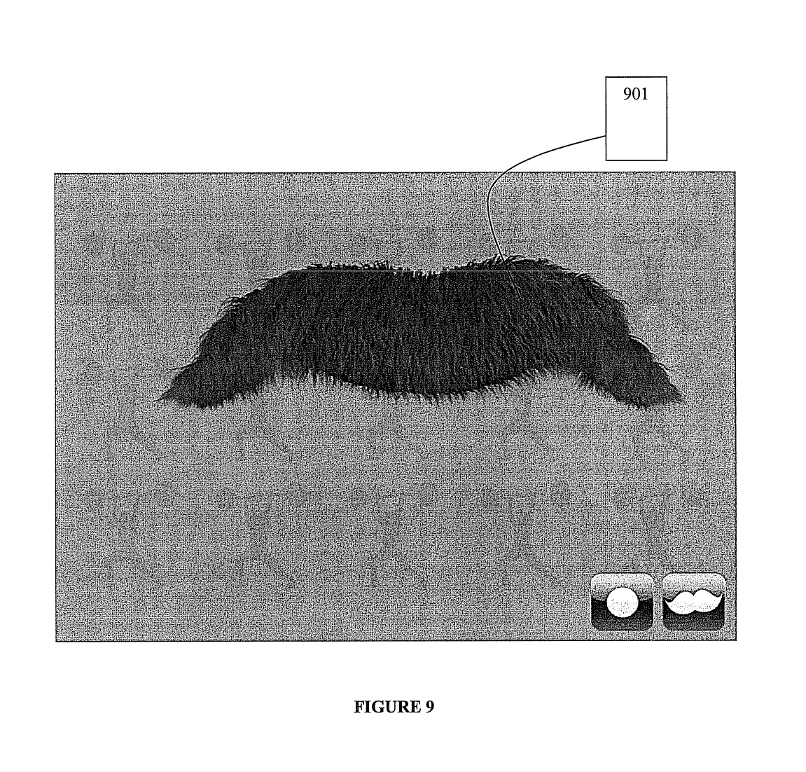

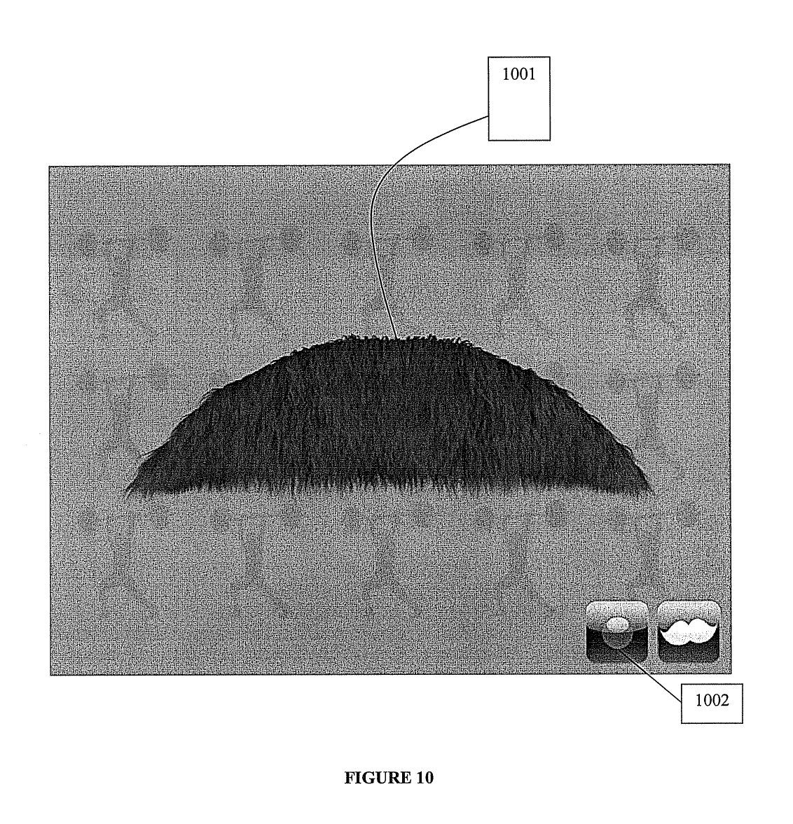

An exemplary view of the digital mustache 601 answering a user's question is shown in screen 801 of FIG. 8 (with “raised” sides of the mustache indicating an audio and/or visual response). In one exemplary embodiment, the digital mustache 601 may be configured to be un-responsive after a pre-set period of inactivity. If said un-responsiveness results, the user 203 may re-“activate” the digital mustache 601 by performing certain motions (e.g. touch screen) or certain actions (e.g. shaking of the device). For instance, screen 901 of FIG. 9 shows a “snoring” digital mustache (with the “pinched” mustache indicating snoring). When the digital mustache 601 becomes un-responsive, the digital mustache 601 may take the same shape as an “active” digital mustache 601 (as shown by the shape in FIG. 7) or may alter its shape to reflect the un-responsiveness. With further reference to FIG. 9, the shape of the digital mustache 601 has changed to reflect a state of un-responsiveness. The snoring digital mustache 601 can be woken up either by voice or sound or by movement (e.g. shaking). The digital mustache 601 then “wakes up” to its “ready” state as shown in screen 1001 of FIG. 10.

The digital mustache may be designed to respond to certain motions (e.g. touching the screen) in one fashion (e.g. audio only, audio plus motion, motion only), while responding to certain actions (e.g. shaking of the device) in a different fashion (e.g. audio only, audio plus motion, motion only).

The entire interaction between the user 203 and the app 204 (via digital mustache 601) may be recorded by activating the record link 1002 shown in FIG. 10. In one exemplary embodiment, the user 203 may record a user input, which includes, but is not limited to, any movement, or sound, or their own voice of asking the digital mustache 601 a question, or making a statement to the digital mustache 601, or making a sound in general, along with the response received from the digital mustache 601 in response to the movement, sound, or question, or statement.

With reference to link 1002 of FIG. 10, the user 203 may tap a “record” 1003 link, or a general area indicative of recording, to begin recording the “interaction” between the user 203 and the digital mustache 601, the interaction comprising the user input and the digital mustache's response. For instance, after tapping the record button, the user 203 may make a movement, or make a sound, or ask the digital mustache 601 a question, or make a statement to the digital mustache 601, and in response, receive a response from the digital mustache 601. This entire “interaction” is then recorded. The user 203 may then tap the “record” 1003 link, or a general area indicative of recording, to stop recording.

With further reference to the user input via a movement, an exemplary embodiment of such input may involve the user 203 shaking the portable computing device 202, as described above with reference to FIG. 10, to “wake” the digital mustache 601, or to re-activate the digital mustache 601. In such embodiment, the recorded interaction includes the user 203 movement to wake the digital mustache 601 and the digital mustache's response to the user input. In one embodiment, the user 203 may be limited to a pre-set time between initiating and ending the recording. For instance, the user 203 may have 45 seconds from the time that the recording begins, to ask the question or make a statement or to make a movement or to make a sound, and receive a response from the digital mustache 601.

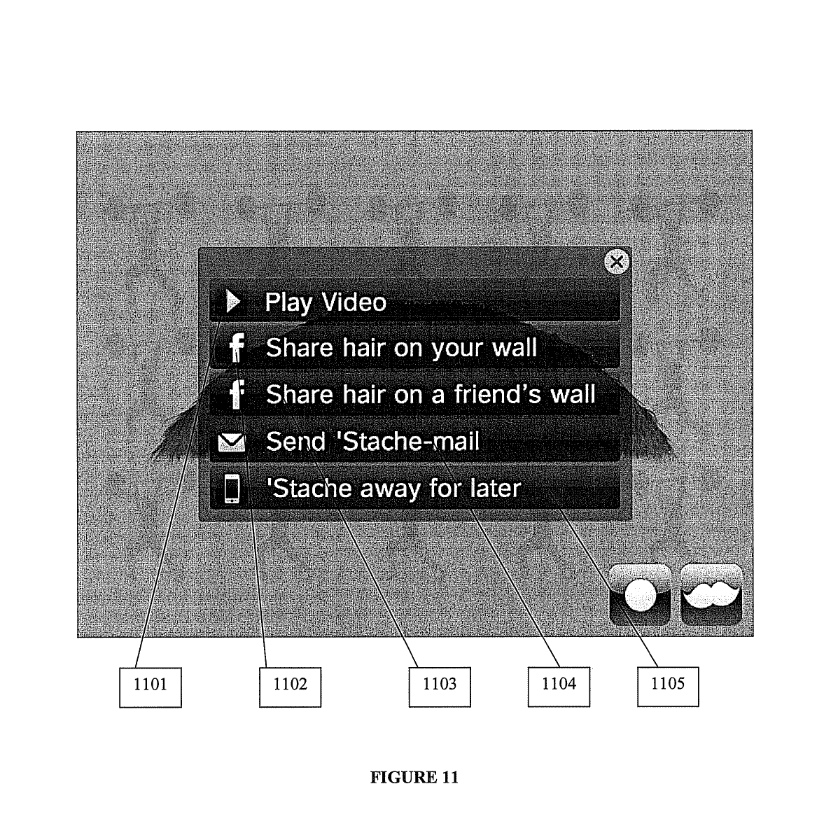

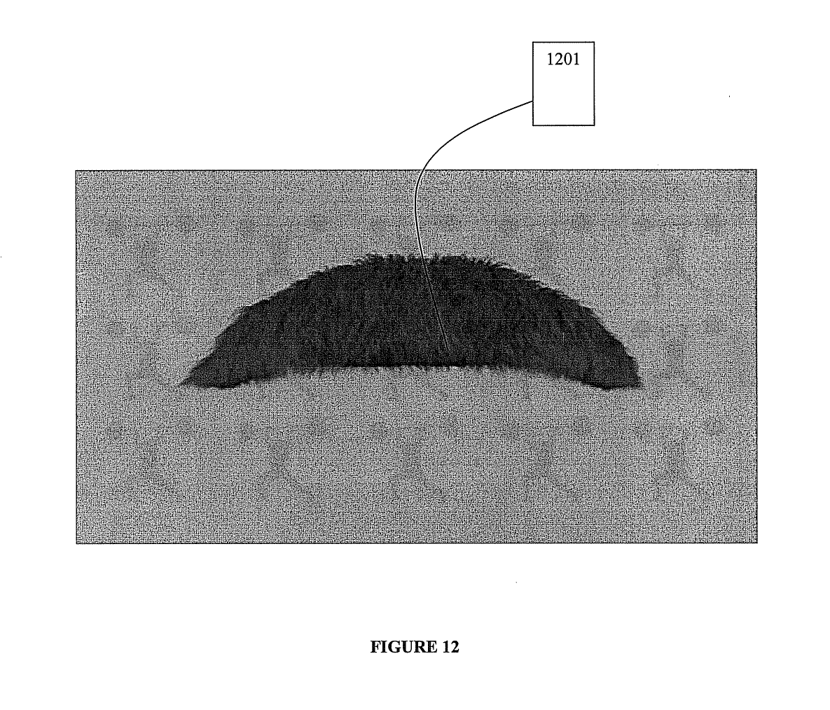

After recording the interaction, the user 203 may be presented with one or more options. For instance, with reference to FIG. 11, the user 203 may be presented with the option of playing the recorded interaction 1101 (as shown in screen 1201 of FIG. 12); sharing the recorded interaction on the user 203′s Facebook® wall 1102; sharing the recorded interaction on the user 203′s friend's Facebook® wall 1103; sending the recorded interaction via email 1104; or to save the recorded interaction for later use 1105.

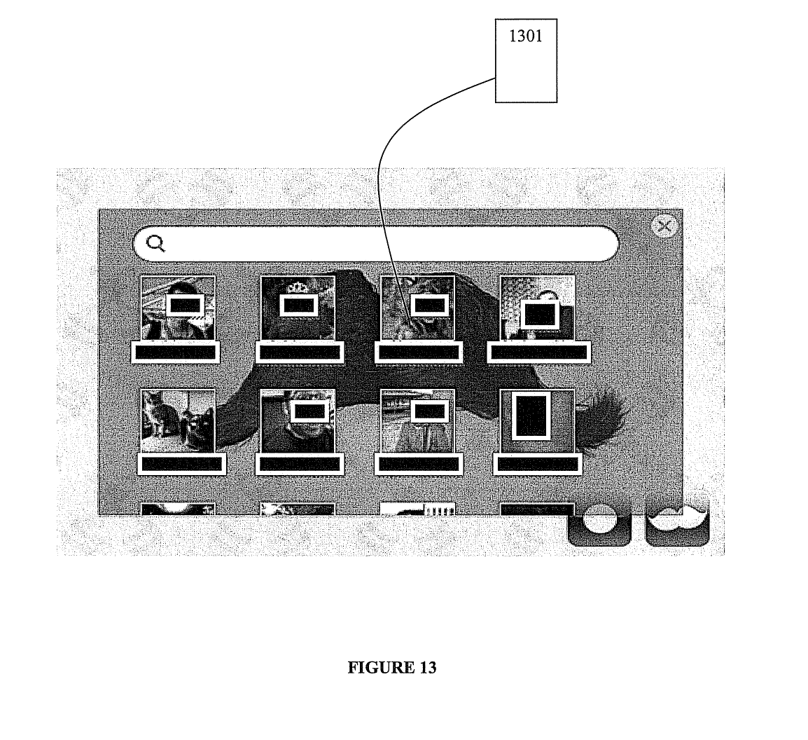

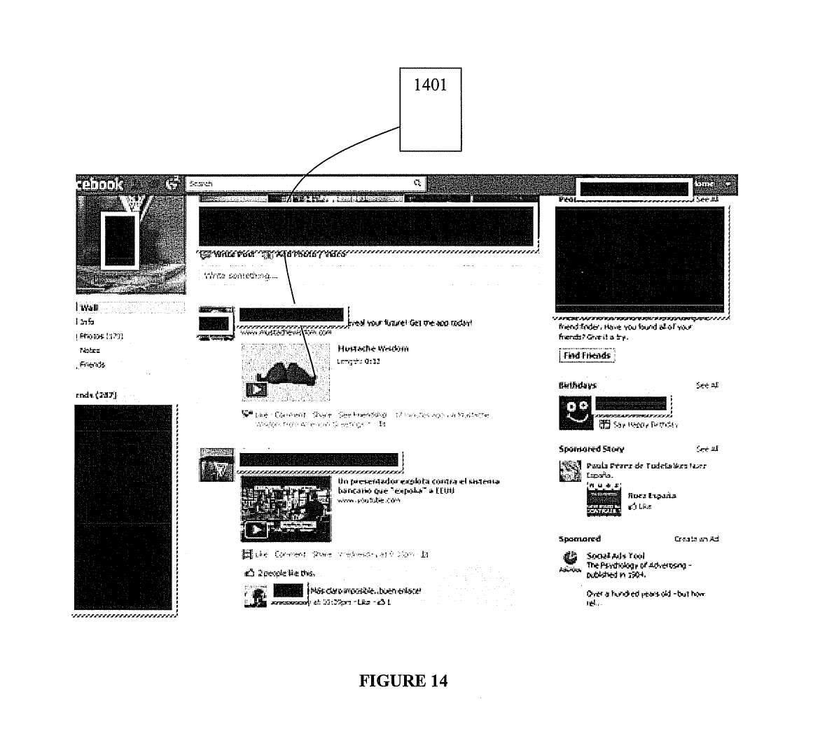

As illustrated in FIG. 13, the user 203 is presented with the option of sharing the recorded interaction on the user's friend's Facebook® page. The user 203 may select one or more Facebook® friends 1301 from the user's Facebook® account, and share the recorded interaction with said friend 1301. The friend's page will be populated with the shared interaction from app 204. The user 203 may also choose to share the recorded conversation on their own Facebook® page, as illustrated by screen 1401 in FIG. 14.

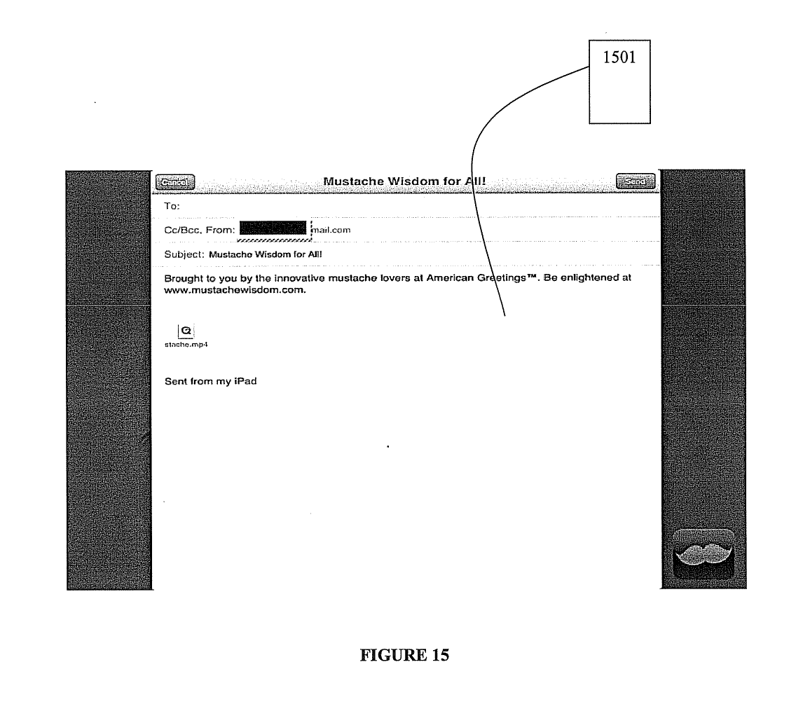

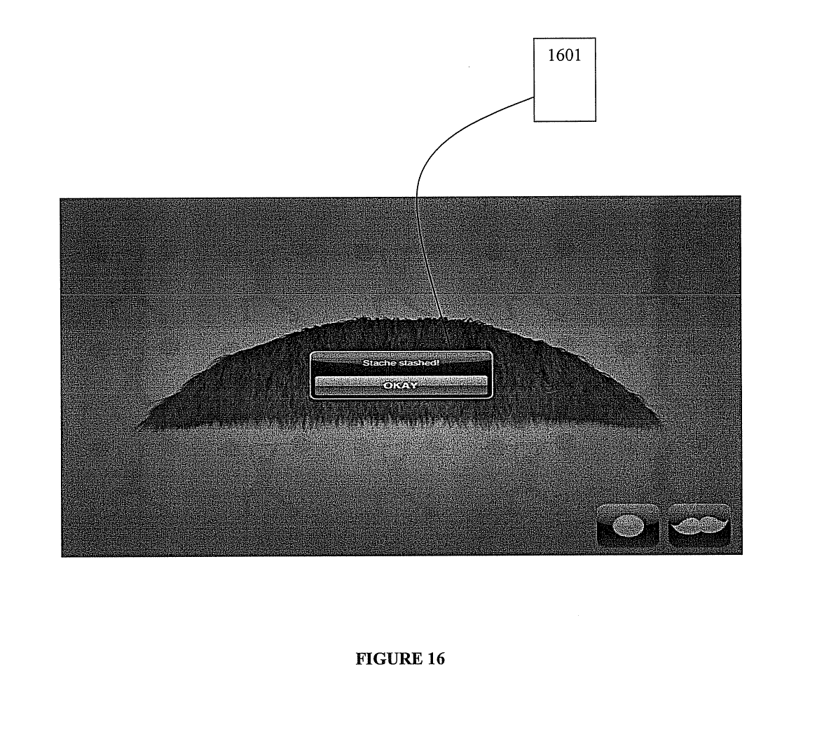

As illustrated by screen 1501 in FIG. 15, user 203 may also share the recorded interaction via email. As illustrated by screen 1601 in FIG. 16, the user 203 may choose to save the recorded interaction for later use. With further reference to FIG. 16, in one exemplary embodiment, when the user 203 chooses to save the recorded interaction for later use, the recorded interaction is saved to the user's native photo and/or video gallery on the portable computing device 202.

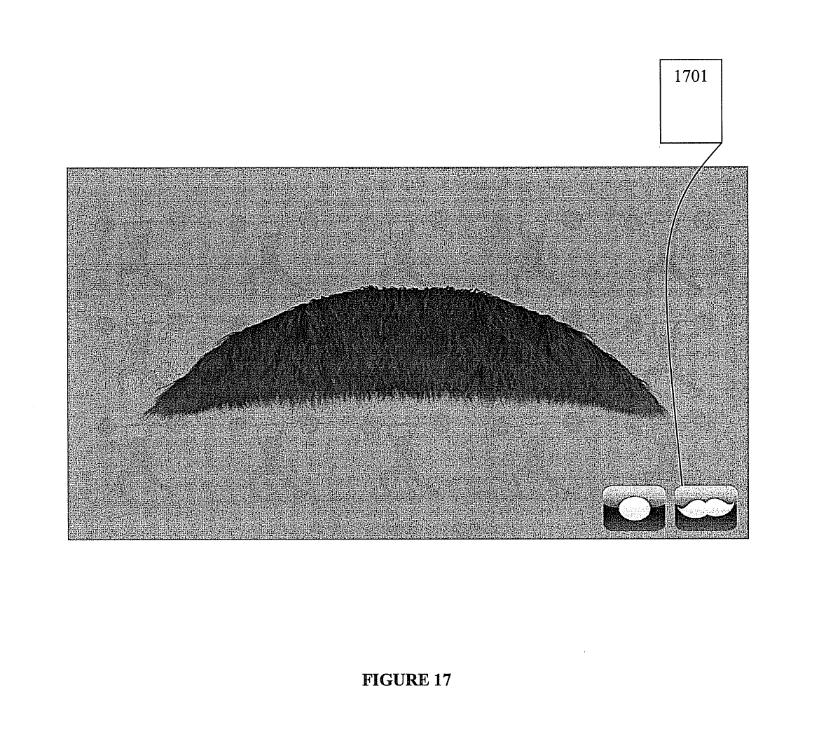

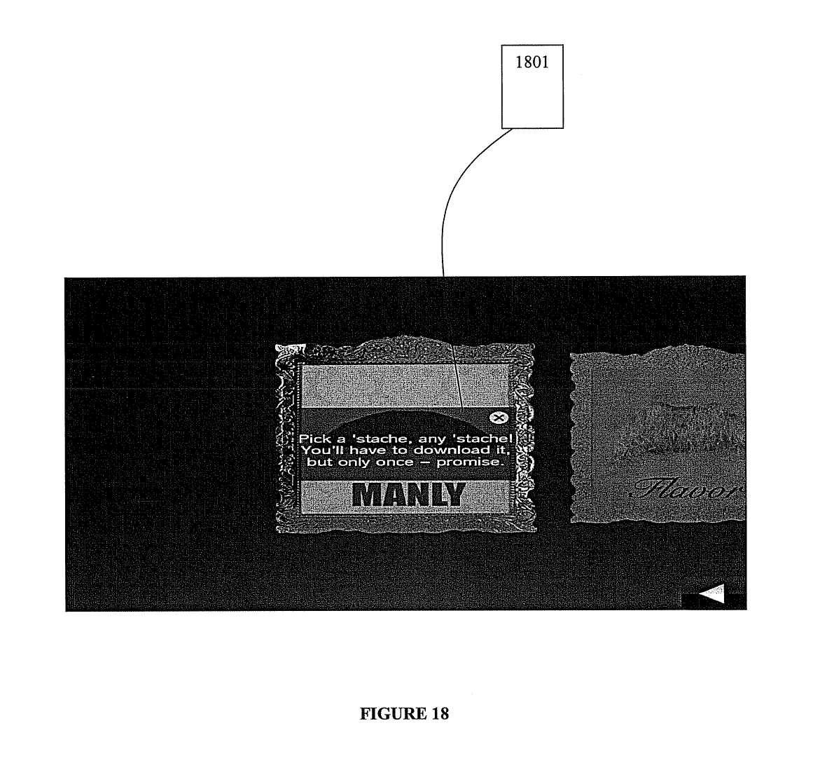

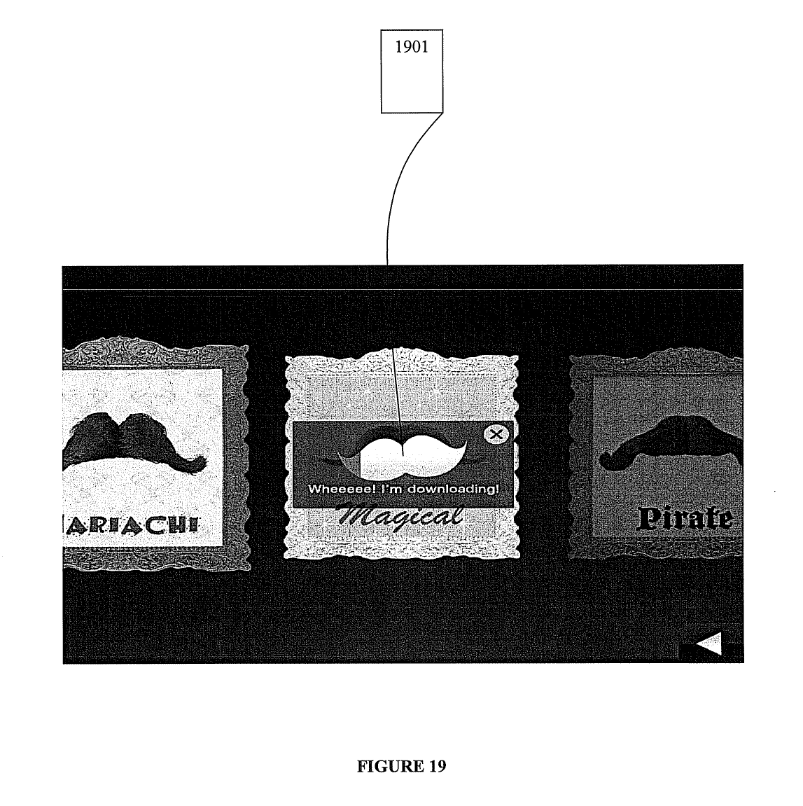

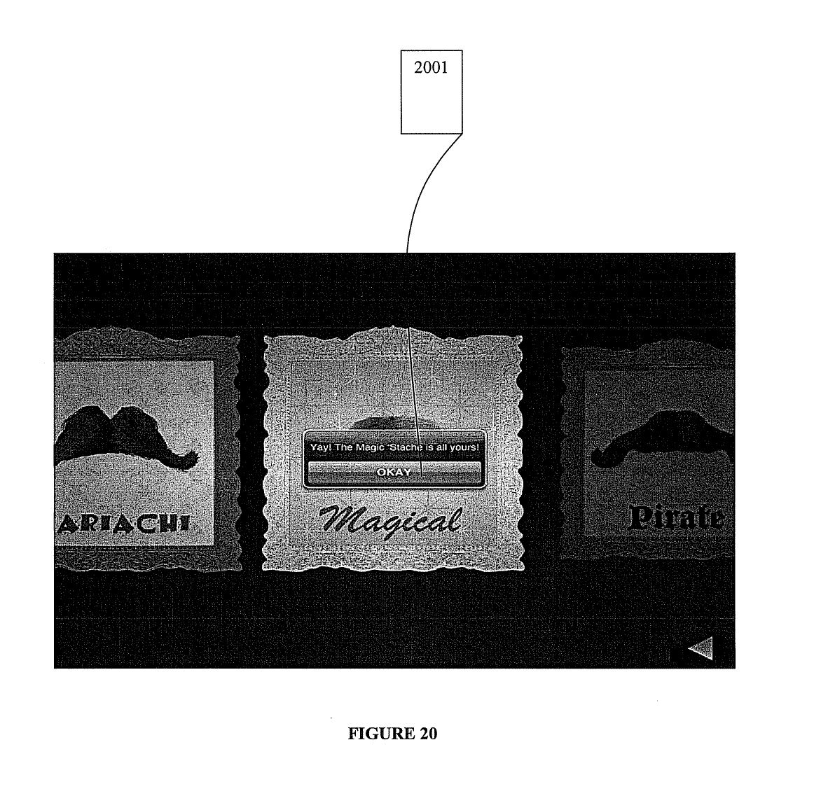

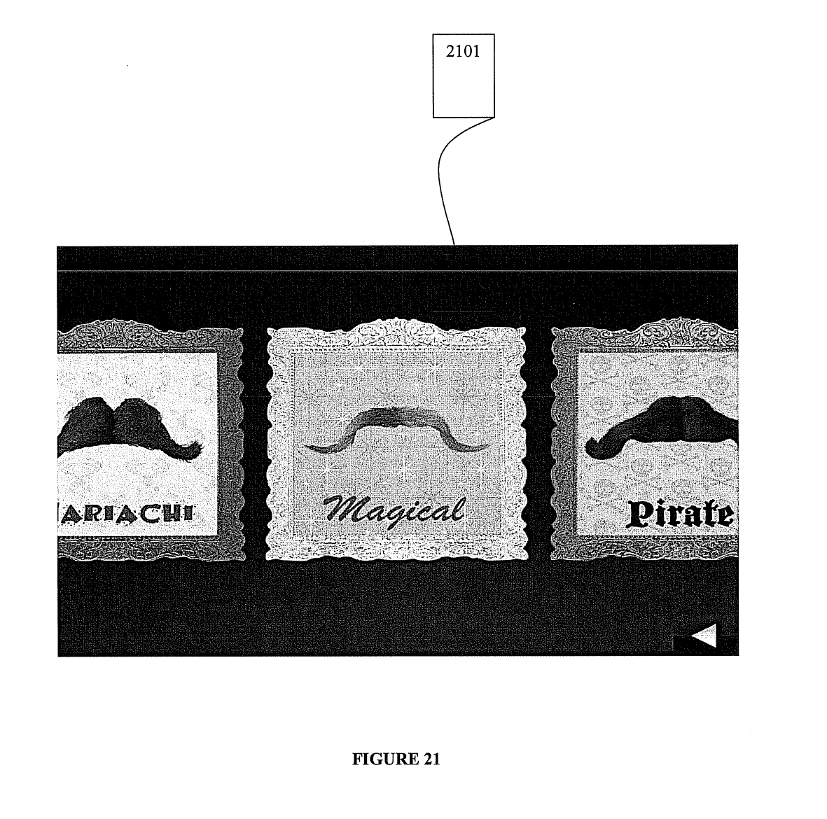

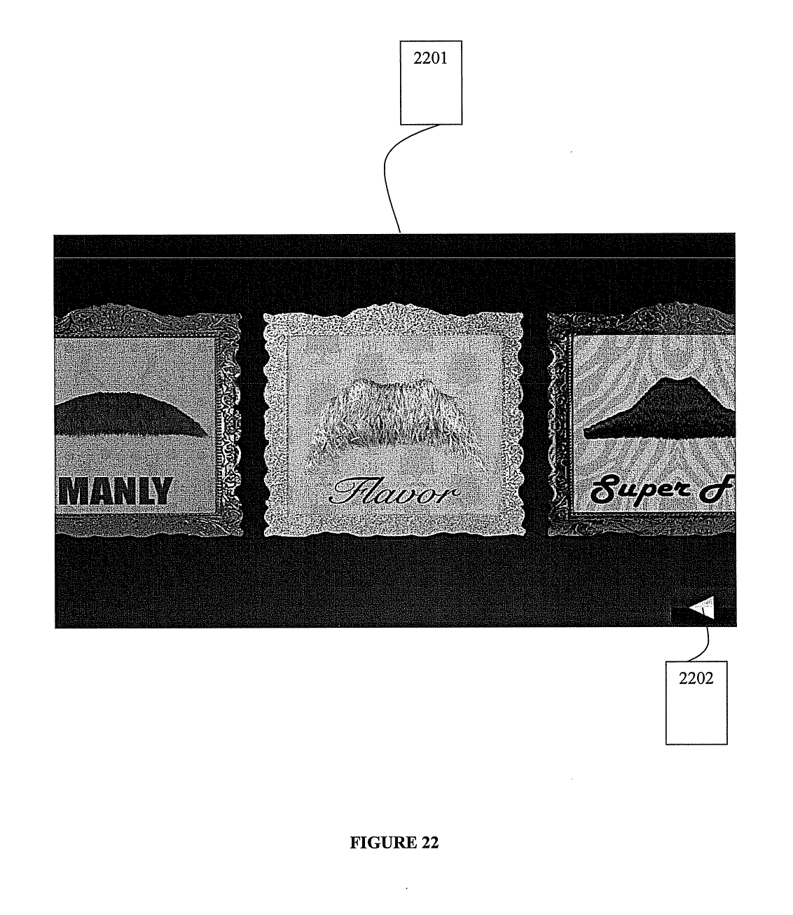

In one exemplary embodiment, the user 203 may be provided with more than one digital mustache 601 to choose from within the app 204. For instance, as illustrated in FIG. 17, the user 203 may tap a digital mustache icon 1701 to launch additional digital mustaches available for the user 203 (as shown in screen 1801 of FIG. 18). Exemplary additional digital mustaches include “seasonal” mustaches such as a “Santa” mustache during Christmas season. The user 203 may be provided with the additional digital mustaches either by way of pre-installed templates, which are ready for use, or by way of download-ready templates, which need to be downloaded and installed before further use. Screen 1901 of FIG. 19 shows user 203 selecting a download-ready digital mustache, and screen 2001 of FIG. 20 shows the selected digital mustache after the download. Screens 2101 and 2201 of FIGS. 21 and 22 respectively show the digital mustaches available to the user 203.

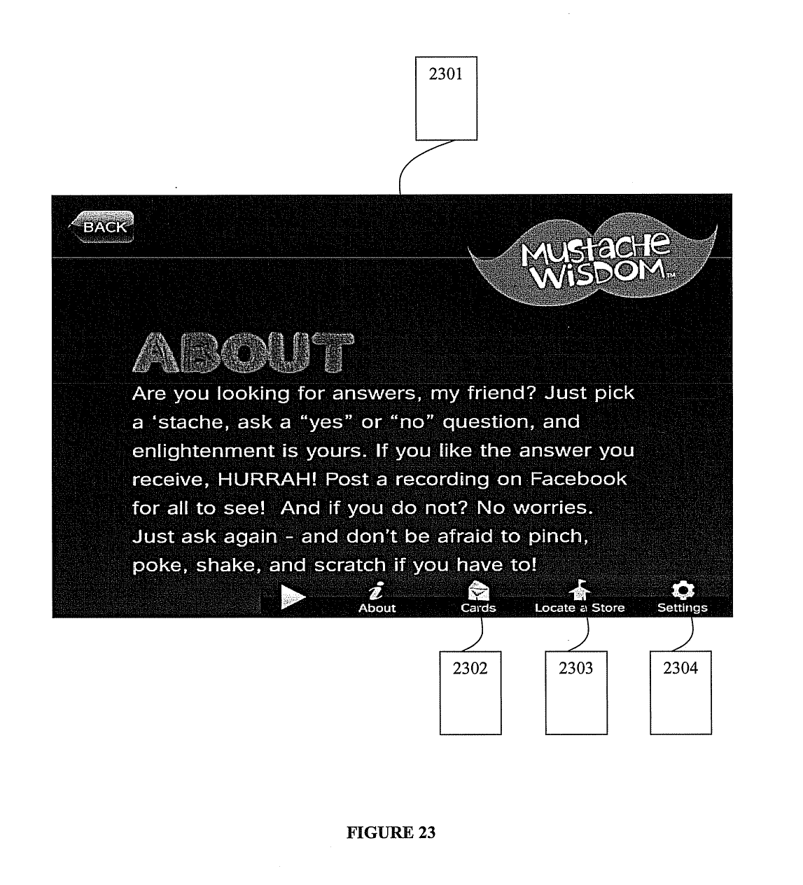

The user 203 may select link 2202 in FIG. 22, or any other area designed to allow the user 203 to enter a menu, to open a menu of items of additional information. The user is directed to a default information page, as shown by the screen 2301 “About” page in FIG. 23. One of ordinary skill in the art will appreciate that any page or screen may be used as the default information page.

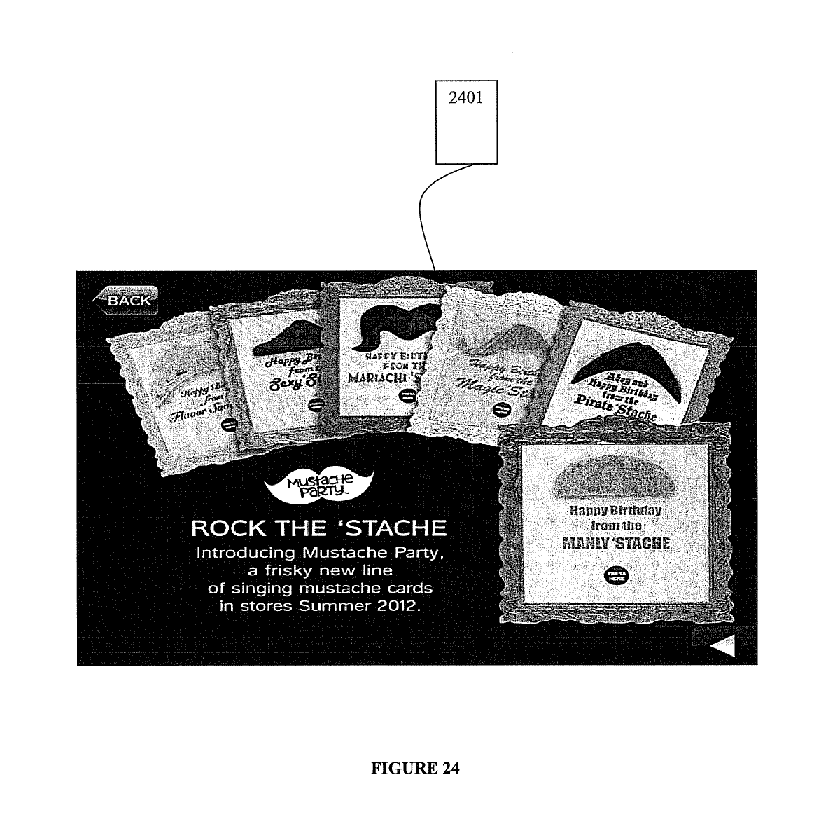

The user 203 may select the Cards link 2302 to view available paper or electronic greeting cards, or any other information, as shown in the exemplary screen 2401 in FIG. 24.

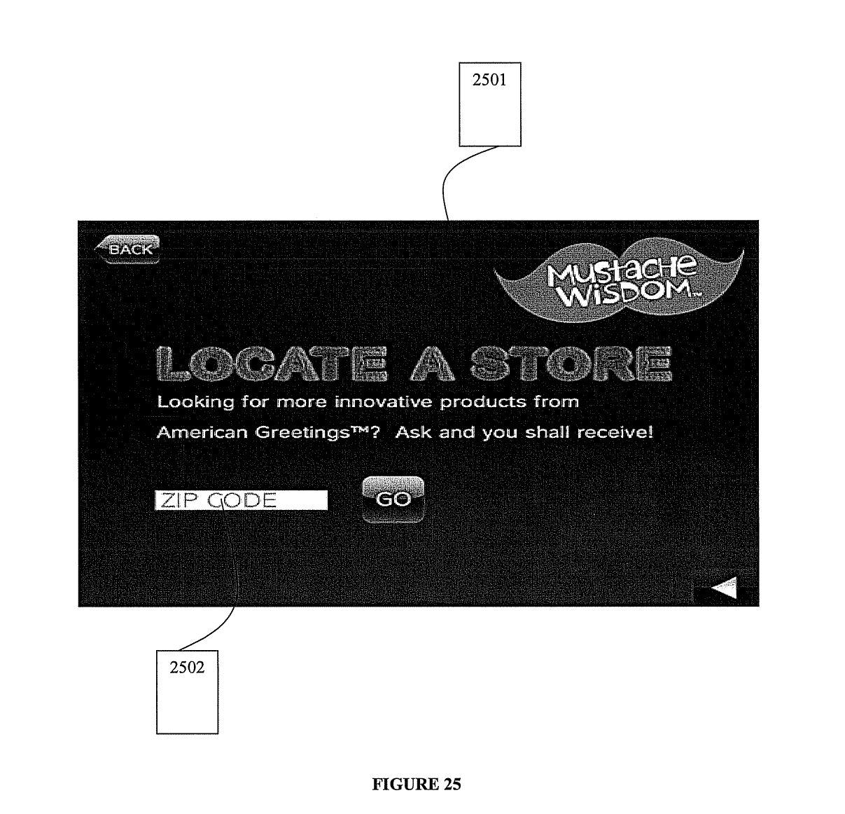

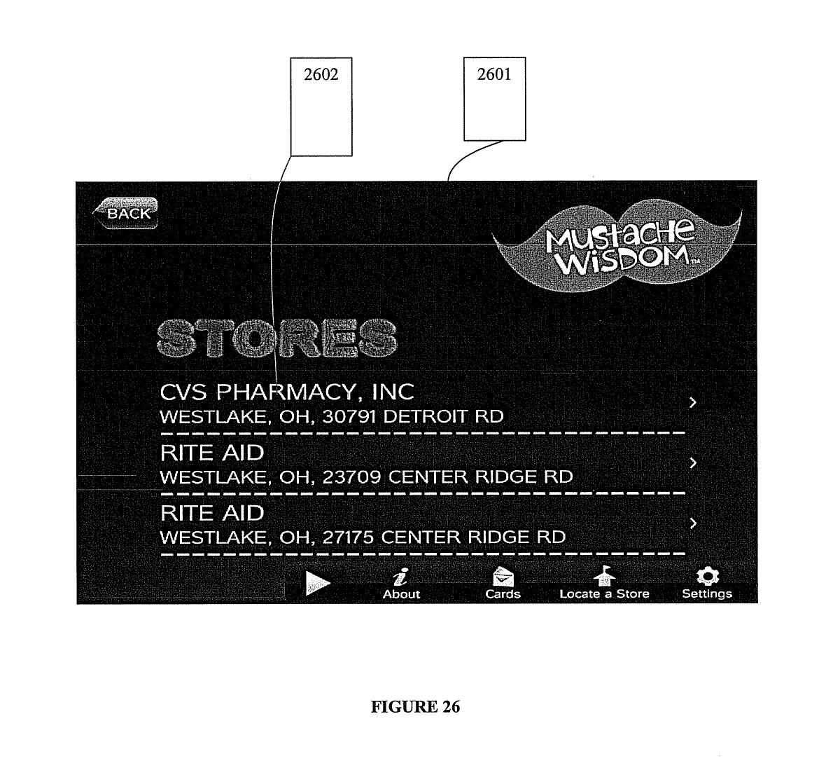

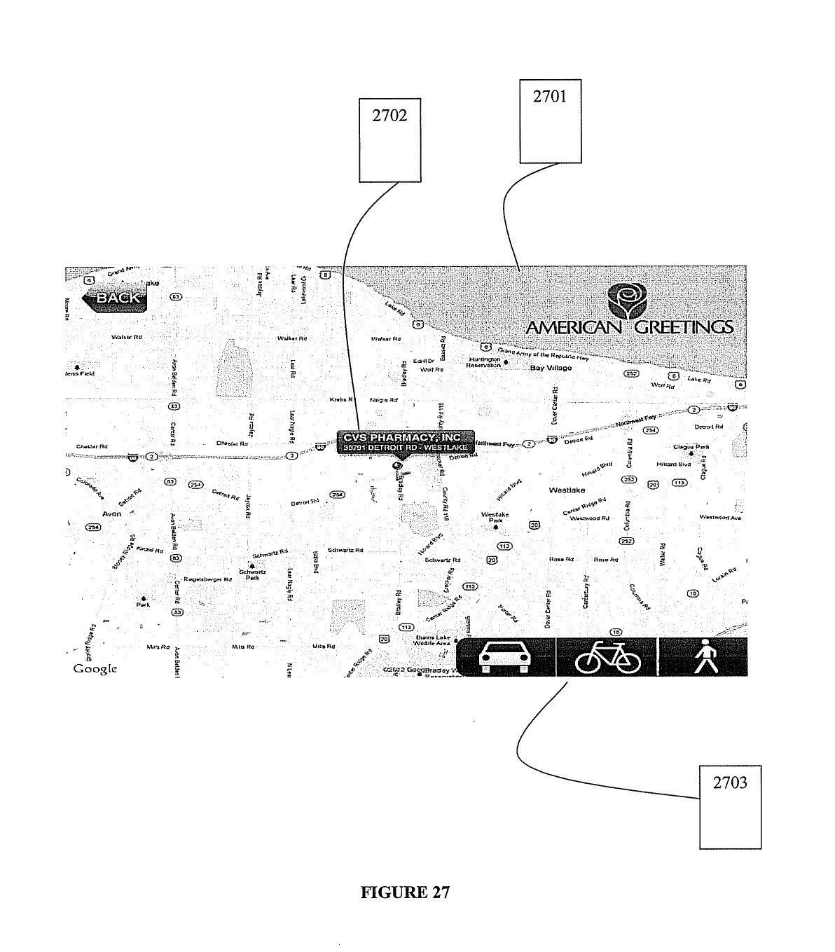

The user 203 may select the Locate a Store link 2303 to locate stores, as shown in screen 2501 of FIG. 25. Here, the user 203 may input a desired zip code or an address or both in field 2502, which will lead the user 203 to a store listing screen 2601 as shown in FIG. 26. User 203 may then select a single store 2602 to view the store's location on a digital map, as seen in screen 2701 of FIG. 27. The specific store's location is displayed as information 2702 in FIG. 27. In one exemplary embodiment, the app 204 may limit the stores displayed and/or calculated to the stores located in the inputted zip code.

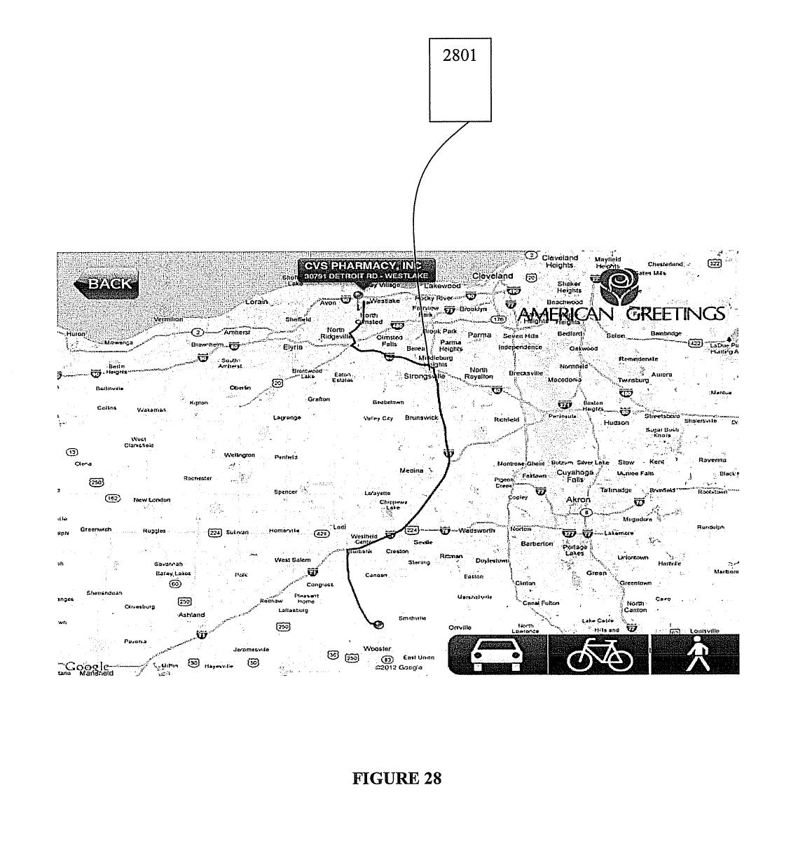

The user 203 may then select the route calculator link 2703 (including, but not limited to, driving, biking, and walking) to allow the app 204 to calculate the distance between the inputted zip code and the address/zip code of selected store. An exemplary route is shown in screen 2801 of FIG. 28.

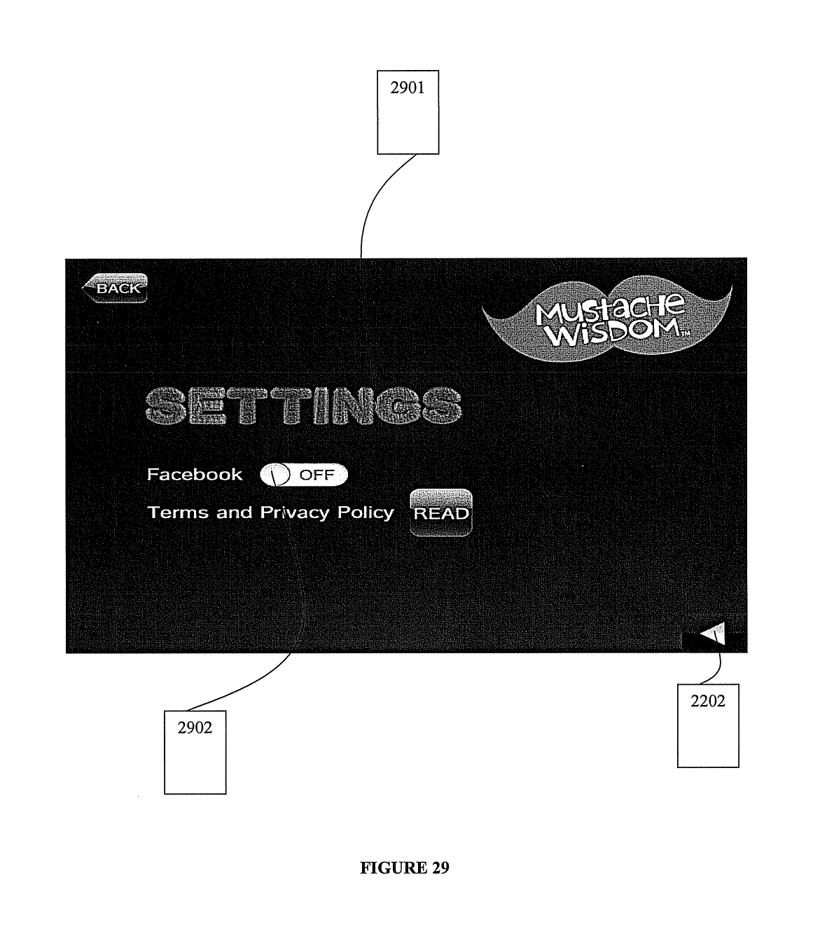

A Settings screen 2901 with various options for privacy, terms of use, and social media use may be presented to the user 203, as shown in FIG. 29. The user 203 may select the Facebook link 2902 to turn off or on their Facebook® login information. The user 203 may also choose to close the menu by selecting the link 2202, as shown in FIG. 29.

The above description of specific embodiments has been given by way of example. From the disclosure given, those skilled in the art will not only understand the general inventive concepts and attendant advantages, but will also find apparent various changes and modifications to the structures and methods disclosed. For example, the general inventive concepts are not typically limited to any particular interface between a user and the user's mobile computing device. Thus, for example, use of alternative user input mechanisms, such as voice commands and keyboard entries, are within the spirit and scope of the general inventive concepts. As another example, although the embodiments disclosed herein have been primarily directed to a portable computing device, the general inventive concepts could be readily extended to a personal computer (PC) or other relatively fixed console computers, and may be pursued with reference to a website and/or other online or offline mechanisms. As another example, although the embodiments disclosed herein have been primarily directed to a mobile application on a portable computing device, the general inventive concepts could be readily extended to a mobile browser. Additionally, other browsing environments which permit the rendering and usage of the interactive greeting card application may be employed. For example, social networking applications such as Facebook® and Twitter® may be utilized to render and use the interactive greeting card's pages (e.g. within the Facebook® browser). It is sought, therefore, to cover all such changes and modifications as fall within the spirit and scope of the general inventive concepts, as described and claimed herein, and equivalents thereof.

1. A machine for creating an interactive message comprising:
an application stored on a portable computing device;
a digital character generated by the application on a portable computing device;
wherein the digital character responds to a user's voice or manual input by providing an audio or visual response; and
wherein the user's voice or manual input and the digital character's audio or visual response are both recorded on the portable computing device as a message.

2. The machine of claim 1 wherein the audio or visual response is randomly generated.

3. The machine of claim 1 wherein the digital character is a digital mustache.

4. The machine of claim 1 wherein the user's input is a voice command.

5. The machine of claim 4 wherein the voice command is a statement.

6. The machine of claim 4 wherein the voice command is a question.

7. The machine of claim 4 wherein the voice command is a sound.

8. The machine of claim 1 wherein the user's input is manual.

9. The machine of claim 8 wherein the manual input of claim 8 is a pinch.

10. The machine of claim 8 wherein the manual input of claim 8 is a tap.

11. The machine of claim 8 wherein the manual input of claim 8 is a double tap.

12. The machine of claim 8 wherein the manual input of claim 8 is a swipe.

13. The machine of claim 8 wherein the manual input of claim 8 is a shake.

14. The machine of claim 1 wherein the audio or visual response is a changed graphical representation of the digital character.

15. The machine of claim 1 wherein the audio or visual response is a changed graphical representation of the digital character accompanied by a sound.

16. The machine of claim 1 wherein the audio visual response is a sound.

17. The machine of claim 1 wherein the audio visual response is a pre-recorded answer.

18. The machine of claim 1 wherein the message is distributed via an internet medium.

19. The machine of claim 18 wherein the internet medium is Facebook®.

20. The machine of claim 18 wherein the internet medium is email.

21. A method of creating a digital interaction comprising:
providing an interactive message application for being downloaded onto a portable computing device wherein the application performs the following steps after being downloaded;
providing a collection of digital characters;
receiving a user's command to select a digital character from the collection;
receiving a manual or voice input from a user;
providing an audio or visual output from the selected digital character in response to the manual or voice input that is intended to generate humor; and
receiving an audio or visual response from the interactive electronic greeting card application.
